(19) United States
(12) Patent Application Publication
(10) Pub. No.: US 2022/0217932 A1
(43) Pub. Date: Jul. 14, 2022

(54) Lid For Container For Hydroponic Plant Growth

(71) Applicant: Jason M. Gotch, Milford, CT (US)

(72) Inventor: Jason M. Gotch, Milford, CT (US)

(21) Appl. No.: 17/145,582

(22) Filed: Jan. 11, 2021

(51) Int. Cl. A01G 31/02; A01G 27/00

(52) U.S. Cl. CPC A01G 31/02; A01G 27/008

(57) ABSTRACT

An apparatus and method for hydroponic plant growth including a water container and a lid removably mounted over the water container. The lid has an opened central portion with an apertured cup holder for a plant extending downwardly from the opened central portion and into the water container when the lid is mounted on the container, and an outer peripheral flange having an upwardly extending mounting element and a downwardly extending mounting element. A water level monitor formed from a transparent sight tube mounted to the upwardly extending mounting element, a float tube mounted to the downwardly extending mounting element, and a float rod freely movable within the float tube and the sight tube, is directly and fixedly mounted to the lid and conjointly movable with the lid. The top of the float rod has an upwardly extending indicator tip, and the bottom of the float rod has a downwardly extending buoyant float ball. The water level monitor is immersed in water within the container when the lid is mounted to the container such that the position of the indicator tip relative to the sight tube indicates the water level in the container. Since the water level monitor is fixedly mounted directly to the lid, it forms part of the lid structure itself and is conjointly movable with the lid.

### NONPROVISIONAL PATENT APPLICATION

Not applicable

### BACKGROUND OF THE INVENTION

The present invention is generally directed to a lid for use on a container for hydroponic plant growth. Conventional hydroponic plant containers include a receptacle for containing the plant. The receptacle is apertured and is received in a container filled with water, so that the receptacle holding the plant is immersed in water entering the receptacle from the water filled container.

In order to accurately monitor the water level in the container, the receptacle holding the plant is removed from the container.

In the alternative, a separate monitor for the water level in the container must be provided and immersed in the container each time the water level in the container is to be checked.

### SUMMARY OF THE INVENTION

The present invention is directed to a lid for a water container for hydroponic plant growth overcoming the need to remove the receptacle holding the plant, or inserting a separate water level monitor in the container, to monitor the water level within the container.

In accordance with the present invention, an apertured receptacle for holding a plant is attached to, or integrally formed with, a lid for the container and extends downwardly from an opened central portion of the lid into the water filled container.

A water level monitoring device is fixedly and directly mounted to, or is integrally formed with, an outer peripheral flange portion of the lid to become a part of the lid structure. Accordingly, the water level monitor is conjointly movable together with the lid.

Once the lid is mounted to the top of the water container, the receptacle holding the plant is received in the water in the container, while a portion of the water level monitoring device on the lid extends into the container and is immersed in the water within the container.

Thereafter, the water level in the container can be monitored by the monitoring device extending from the lid into the container without removing the lid from the container and without employing any separate monitoring device. This feature of the invention is significant if the water container is formed from a nontransparent material which would require removal of the lid to visually observe the water level within the container.

### BRIEF DESCRIPTION OF THE DRAWINGS

FIG. 1 illustrates a side elevational view in section of the assembled plant container in accordance with the present invention;

FIG. 2 illustrates a perspective partial cut away side elevational view of the lid for the plant container illustrated in FIG. 1 before the water level monitoring device has been mounted to the lid of the plant container; and

FIG. 3 illustrates a perspective view of the lid illustrated by FIG. 2 as seen from the top.

### DESCRIPTION OF THE BEST MODES FOR CARRYING OUT THE INVENTION

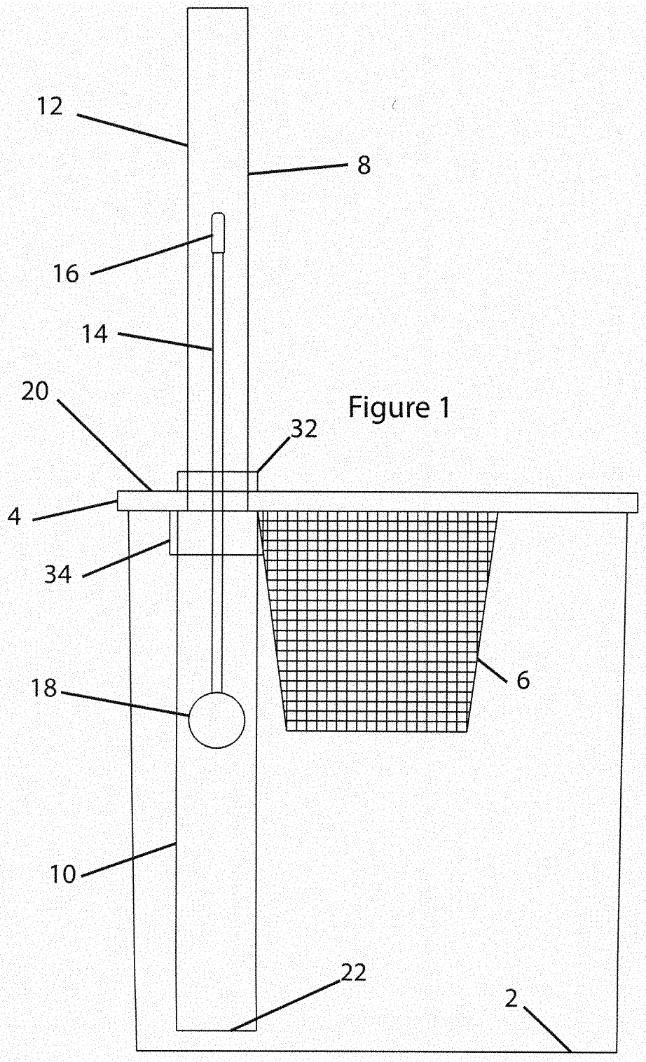

FIG. 1 of the drawing illustrates an assembled plant container for hydroponic plant growth in accordance with the present invention.

A water container is generally designated by reference numeral 2. A removable lid for the water container is generally designated by reference numeral 4, while an apertured cup for holding a plant is generally designated by reference numeral 6. The cup, which is preferably integrally formed with the lid, extends downwardly from the lower surface of an opened central portion of the lid and into the container 2 so that water from the container enters the cup through the apertures in the cup.

A water level monitoring device assembled directly on the lid and fixedly mounted thereto is generally designated by reference numeral 8. The monitoring device is formed from a float tube designated by the reference numeral 10, a sight tube 12 formed from a transparent plastic material, and a float rod 14 having an indicator tip 16 at the top end thereof and a buoyant float ball 18 at the bottom end thereof. The float rod is received within the assembled sight tube and float tube such that the indicator tip is received within the upper sight tube and the float ball is received within the lower float tube.

The monitoring device 8, as shown in its assembled configuration, is fixedly and directly mounted to an outer peripheral flange portion 20 of the lid such that the sight tube 12 and the float tube 10 are in fluid communication with each other, and the float rod 14 is freely movable between the sight tube and the float tube. Since the water level monitoring device in its assembled configuration is fixedly and directly mounted to the flange of the lid, it is conjointly movable together with the lid.

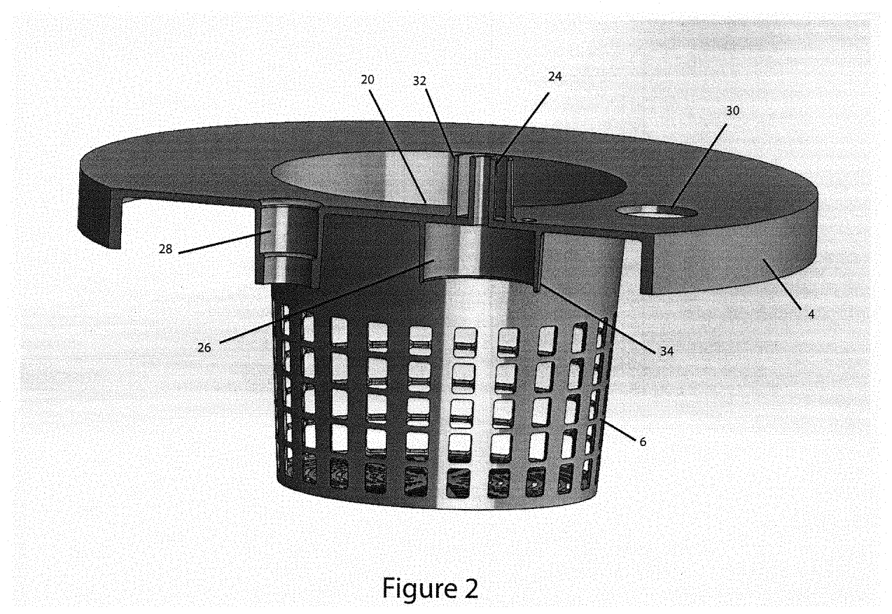

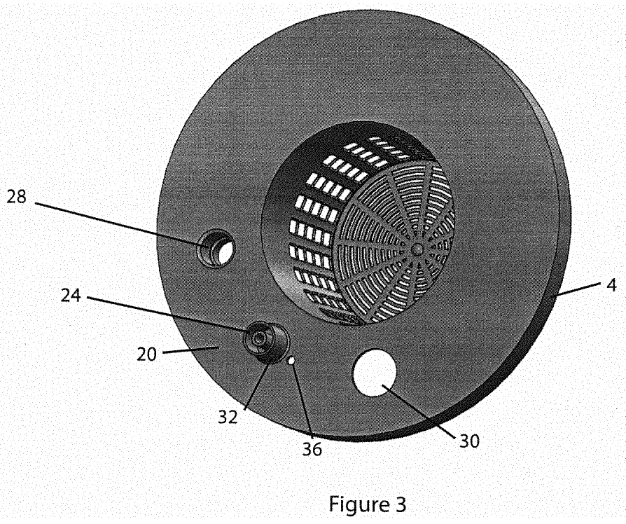

A mounting flange 32 extends upwardly from the upper surface of the outer peripheral flange 20 of the lid, and a mounting flange 34 extends downwardly from the lower surface of the outer peripheral flange 20 of the lid. The mounting flange 32 surrounds an upper mounting element 24 (as shown in FIGS. 2 and 3) for mounting the sight tube 8 to the upper surface of the lid, and the mounting flange 34 surrounds a lower mounting element 26 (as shown in FIG. 2) for mounting the float tube 10 to the lower surface of the lid.

The bottom end 22 of the float tube 10 is opened so that water from the water container 2 freely flows into the float tube through the opened bottom of the float tube.

FIG. 2 of the drawing is a side elevational view of the lid 4 of the plant container before the water level monitoring device is mounted thereon. The apertured cup 6 for holding a plant extends downwardly from the lower surface of the lid 4. An upper tubular mounting element 24 surrounded by an upper mounting flange 32 extends upwardly from the upper surface of the flange 20 of the lid, while a lower tubular mounting element 26 surrounded by a lower mounting flange 34 extends downwardly from the lower surface of the flange 20 of the lid. The bottom of the sight tube 12 is mounted to the upper mounting element 24 and upper mounting flange 32, while the top of the float tube 10 is mounted to the lower mounting element 26 and the lower mounting flange 34. In this manner, the sight tube 12 extends above the flange 20 of the lid, and the float tube 10 extends below the flange 20 of the lid, when the monitoring device is mounted to the lid as illustrated by FIG. 1.

The upper and lower tubular mounting elements 24 and 26 as well as the flange 20 of the lid have openings in axially alignment with each other so that the float rod is freely movable between the sight tube and the float tube through the axially aligned openings. The diameter of the opening in the upper mounting element 24 is smaller than the diameter of the indicator tip 16, while the diameter of the opening in the lower mounting element 26 is smaller than the diameter of the float ball 18. In this manner, the indicator tip at the top of the float rod 14 remains in the upper sight tube, and the float ball at the bottom of the float rod 14 remains in the lower float tube, as the float rod moves axially between the inside of the float tube and the inside of the sight tube.

An opened tube 28 is defined in the flange of the lid to provide the ability to install a snap-in hose fitting. An opening 30 is defined in the flange of the lid to provide for air circulation in and out of the container 2 when the lid 4 is mounted to the container. Both openings can also be used to add water to the container without removing the lid from the container.

FIG. 3 of the drawing is a top perspective view of the lid illustrated by FIG. 2 showing the apertured plant holder cup integrally extending downwardly from the opened center region of the lid 4, as well as the upper mounting element 24 and its surrounding upper mounting flange 32, the snap-in hose opening 28, and the air flow opening 30 in the outer peripheral flange portion 20 of the lid 4. A smaller opening 36 provides a vent for equalizing air pressure within the container 2 as the rod 14 moves up and down within the float tube 10.

In operation, the assembled water level monitor 8 is fixedly mounted to the flange 20 of the removable lid 4. When the lid 4 is placed atop the water container 2 as shown by FIG. 1, the float tube 10 is immersed in water in the container 2. Water in the container enters the cup 6 holding a plant if the water level in the container is sufficiently high. Water from the container also enters the float tube 10 from the open bottom 22 of the float tube to control the position of the buoyant float ball 18 within the float tube. The position of the float ball in the float tube controls the position of the indicator tip 16 at the top of the indicator rod relative to the transparent sight tube. When the water level in the container is high, and thus the water level in the float tube is high, the position of the indicator tip at the top of the float rod will be high. When the water level in the container is low, and thus the water level in the float tube is low, the position of the indicator tip at the top of the float rod will be low. Thus, visual observation of the position of the indicator tip in the transparent float tube indicates the relative level of water in the container. Gradient indicia can be applied to the sight tube to provide a more precise indication of the water level in the container.

The water level monitor as disclosed and illustrated herein provides a simple and economic manner of monitoring the water level in a container for hydroponic plant growth. The monitoring device is fixedly mounted directly to a removable lid for the container, thereby becoming part of the lid structure so that it is unnecessary to remove the monitor from the lid when the lid is removed from the container since the monitoring device is conjointly movable with the lid.

The components of the plant container disclosed herein are formed from conventional materials such as PVC plastics, while the float ball is formed from conventional buoyant materials such as foam.

The discussion of the best modes for carrying out the invention in conjunction with the drawings of this patent application, as disclosed and illustrated herein, is intended to be illustrative only and not restrictive of the scope of the invention, that scope being defined by the following claims and all equivalents thereto.

1. An apparatus for hydroponic plant growth, said apparatus comprising a container for water, a removable lid for said container, said lid having an opened central portion and an outer peripheral flange, an apertured holder for a plant mounted to or formed with the lid and extending downwardly from the open central portion of the lid, and a water level monitor operatively associated with said flange of said removable lid for monitoring the water level in said container when said lid is placed atop the container, said water level monitor being fixedly attached to the flange of said lid and conjointly movable with said lid.

2. The apparatus as claimed in claim 1, wherein said lid includes mounting elements for said water level monitor.

3. The apparatus as claimed in claim 2, wherein said mounting elements include an upper mounting element extending upwardly from a top surface of said flange of said lid, and a lower mounting element extending downwardly from a bottom surface of said flange of said lid.

4. The apparatus as claimed in claim 3, wherein said upper and lower mounting elements are tubular in shape, each of said mounting elements defining an opening therein.

5. The apparatus as claimed in claim 4, wherein the openings in said upper and lower mounting elements are in axial alignment with each other and in axial alignment with an opening in said flange.

6. The apparatus as claimed in claim 5, wherein said water level monitor includes a first upper tube fixedly attached to the upper mounting element, and a second lower tube fixedly attached to the lower mounting element.

7. The apparatus as claimed in claim 6, wherein said second lower tube has an opened bottom which is in fluid communication with water in the container when the lid is placed atop the container.

8. The apparatus as claimed in claim 7, wherein said water level monitor includes a rod received in said aligned openings in said upper and lower mounting elements and in said flange, said rod being movable between said first upper tube and said second lower tube in dependence upon the level of water in said container when the lid is mounted atop the container.

9. The apparatus as claimed in claim 7, wherein said first upper tube is transparent, and a water level indicator is attached to the top of said rod and movable with said rod inside of the first upper tube.

10. The apparatus as claimed in claim 7, wherein a buoyant element is attached to the bottom of said rod, and movable inside of the second lower tube in dependence upon the water level in said container.

11. A removable lid for a plant container for hydroponic plant growth, said lid having an open central portion and an outer peripheral flange, said lid comprising a water level monitor for monitoring the level of water in the container when the lid is placed atop the container, said water level monitor fixedly mounted to the flange of said lid and conjointly movable with said lid.

12. The lid as claimed in claim 11, wherein, said lid includes integrally formed mounting elements for said water level monitor.

13. The lid as claimed in claim 12, wherein said mounting elements include an upper mounting element extending upwardly from a top surface of said flange of said lid, and a lower mounting element extending downwardly from a bottom surface of said flange of said lid.

14. The lid as claimed in claim 13, wherein said upper and lower mounting elements are tubular in shape, each of said mounting elements defining an opening therein.

15. The lid as claimed in claim 14, wherein the openings in said upper and lower mounting elements are axially aligned with each other and axially aligned with an opening in said flange.

16. The lid as claimed in claim 15, wherein said water level monitor includes a first upper tube fixedly attached to the upper mounting element, and a second lower tube fixedly attached to the lower mounting element.

17. The lid as claimed in claim 16, wherein said second lower tube has an opened bottom which is in fluid communication with water in the container when the lid is placed atop the container.

18. The lid as claimed in claim 17, wherein said water level monitor includes a rod received in said axially aligned openings in said upper and lower mounting elements and in said flange, said rod having a water level indicator attached to the top thereof and a buoyant element attached to the bottom thereof, said rod being movable between said first and second tubes in dependence upon the level of water in said container when the lid is mounted atop the container.

19. A method of hydroponic plant growth, said method including the steps of:
providing a water container and an apertured holder for a plant arranged so that a plant in the holder is received in water in the container,
providing a removable lid for the container having an outer peripheral flange portion and an open central portion, and affixing the apertured holder to the lid so that it extends downwardly through the central opening of the lid;
fixedly mounting a water level monitor to the flange of the lid such that the water level monitor is conjointly movable with the lid; and
arranging the water level monitor such that it is received in the container for measuring the level of water in the container when the lid is placed atop the container.

20. The method as claimed in claim 19, further including the step of:
arranging the water level monitor on said lid such that it is in direct fluid communication with water in the container.
